(19) United States
(12) Patent Application Publication
(10) Pub. No.: US 2012/0264037 A1
(43) Pub. Date: Oct. 18, 2012

(54) COMPOSITE BIPOLAR PLATE

(76) Inventors: Chung-Jen TSENG, Taoyuan County (TW); Feng-Chang CHEN, Taoyuan County (TW)

(21) Appl. No.: 13/344,950

(22) Filed: Jan. 6, 2012

(30) Foreign Application Priority Data
Apr. 15, 2011 (TW) 100113239

(51) Int. Cl. H01M 8/04

(52) U.S. Cl. 429/518

(57) ABSTRACT

A composite bipolar plate includes a frame defining therein an inner edge and a first inlet and a first outlet at the inner edge, a bonding layer bonded to the inner edge of the frame, and a runner plate defining a plurality of flow channels and a second inlet and a second outlet respectively disposed in communication with the flow channels and being bonded to the bonding layer to become affixed to the frame and to have the second inlet be connected to the first inlet and the second outlet be connected to the first outlet for enabling a fuel to flow from the second inlet into the flow channels toward the outside of the runner plate via the second outlet.

### BACKGROUND OF THE INVENTION

1. Field of the Invention

The present invention relates to fuel cells and more particularly, to a composite bipolar plate for fuel cells.

2. Description of the Related Art

Many different fuel cell batteries are known. Among the conventional fuel cells, proton exchange membrane fuel cells (PEMFC) is an optimal one practical for use in 3C home appliances or for home application. In a proton exchange membrane fuel cell, a membrane electrode assembly is provided comprising a proton permeable membrane bonded on one side to an anode and bonded on the opposite side to a cathode. In the aforesaid proton exchange membrane fuel cell architecture, the bipolar plate acts an important role. It isolates the reaction gas, conducts electric current, supports the electrodes, and provides heat dissipation and water drainage functions. Therefore, a bipolar plate is a key component in a proton exchange membrane fuel cell.

At the present time, commercial bipolar plates include metal bipolar plates and graphite bipolar plates. A metal bipolar plate has the advantages of high conductivity, excellent machinability and reasonable price; however, its drawback of heavy weight must be further studies and settled. A graphite bipolar plate normally uses a 3-4 mm thick graphite plate material that is processed by a milling machine to provide the desired flow channels and outer frame. A graphite bipolar plate is corrosion preventive and has excellent electrical conductivity. However, graphite has the drawbacks of high fragility, low machinability and high unit cost.

### SUMMARY OF THE INVENTION

The present invention has been accomplished under the circumstances in view. It is the main object of the present invention to provide a composite bipolar plate, which is lighter than a conventional metal bipolar plate having the same dimension.

It is another object of the present invention to provide a composite bipolar plate, which buffers external pressure to protect against cracking and has an average manufacturing cost much cheaper than conventional graphite bipolar plates.

To achieve these and other objects of the present invention, a composite bipolar plate comprises a frame defining therein an inner edge and a first inlet and a first outlet at the inner edge, a bonding layer bonded to the inner edge of the frame, and a runner plate defining a plurality of flow channels and a second inlet and a second outlet respectively disposed in communication with the flow channels and being bonded to the bonding layer to become affixed to the frame and to have the second inlet be connected to the first inlet and the second outlet be connected to the first outlet for enabling a fuel to flow from the second inlet into the flow channels toward the outside of the runner plate via the second outlet.

Thus, in one same dimension, the composite bipolar plate is much lighter than a conventional metal bipolar plate. Further, because the graphite runner plate is bonded to the flexible frame, the flexible frame buffers external pressure, protecting the graphite runner plate against cracking. Further, because the frame is suitable for mass production by means of injection molding, the average manufacturing cost of the composite bipolar plate is relatively lower than the conventional bipolar plates.

### BRIEF DESCRIPTION OF THE DRAWINGS

Other features and advantages of the present invention will be understood by reference to the following specification in conjunction with the accompanying drawings, which like reference signs denote like elements of the structure.

FIG. 1 is an oblique top elevational view of a composite bipolar plate in accordance with the present invention.

FIG. 2 is an exploded view of the composite bipolar plate in accordance with the present invention.

FIG. 3 is a sectional view taken along line 3-3 of FIG. 1, illustrating the flow channels located on one side of the runner plate.

FIG. 4 is similar to FIG. 3 but illustrating the flow channels located on the two opposite sides of the runner plate.

### DETAILED DESCRIPTION OF THE INVENTION

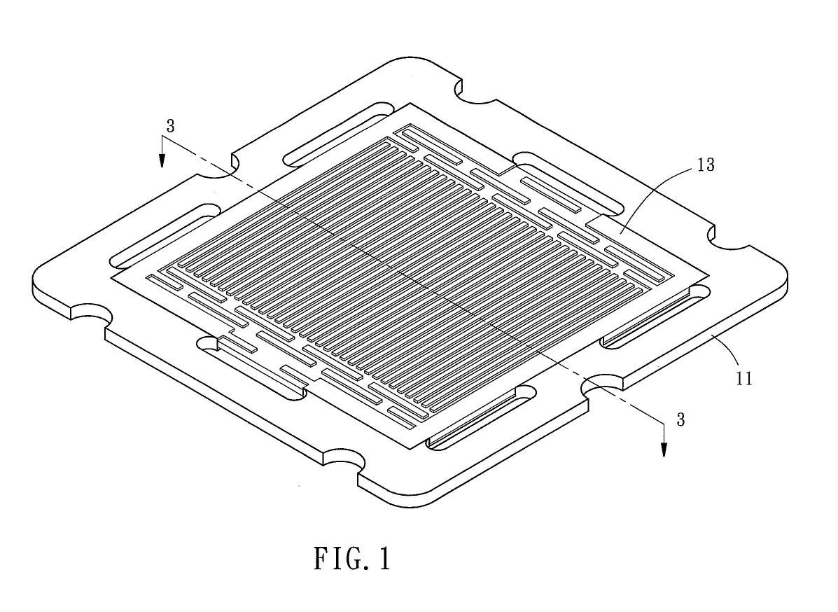

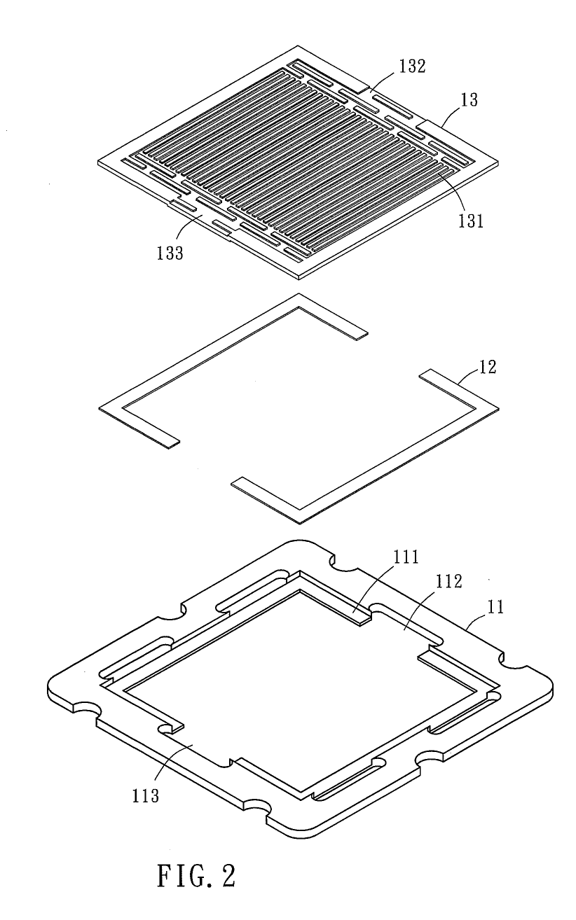

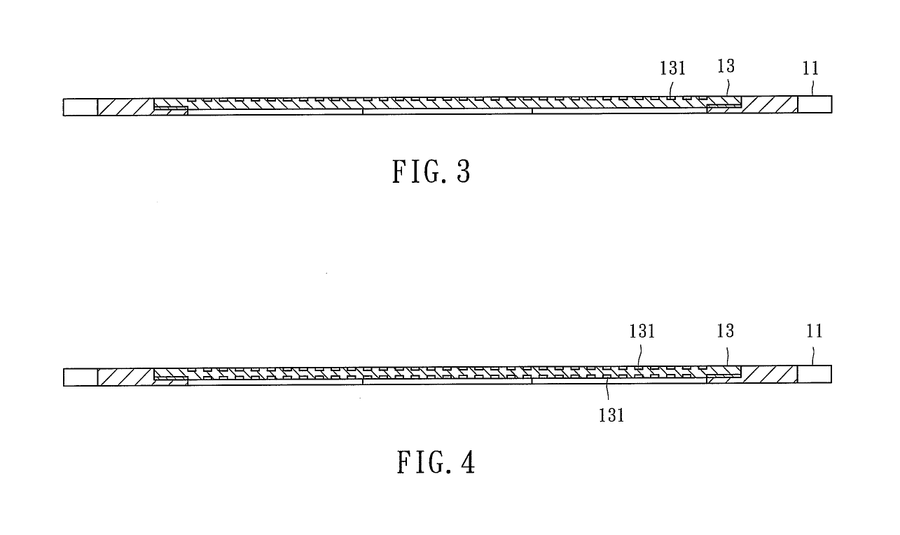

Referring to FIGS. 1-3, a composite bipolar plate in accordance with the present invention is shown comprising a frame 11, a bonding layer 12 and a runner plate 13.

The frame 11 comprises an inner edge 111, a first inlet 112 and a first outlet 113 defined at the inner edge 111. It is to be noted that, in this embodiment, the thickness of the frame 11 can range from 0.75 mm to 10, preferably within 0.75 mm˜3 mm. Further, the frame 11 is selected from the material group of polyester, polyamide, polystyrene, polyolefin consisting of polyethylene and polypropylene, and their copolymers.

The bonding layer 12 is bonded to the inner edge 111 of the frame 11. Further, the bonding layer 12 is selected from the group of silicone resin, epoxy resin, acrylic resin and bicomponent resins polymerized from polyester and urethane.

The runner plate 13 defines a plurality of flow channels 131 and a second inlet 132 and a second outlet 133 in communication with the flow channels 131. The runner plate 13 is bonded to the bonding layer 111, becoming thereby affixed to the frame 11. The second inlet 132 is kept in communication with the first inlet 112. The second outlet 133 is kept in communication with the first outlet 113. Thus, fuel flows through the second inlet 132 into the flow channels 131 toward the outside of the runner plate 13 via the second outlet 133. The thickness of the runner plate 13 is within the range of 0.75 mm˜10 mm, or preferably within the range of 0.75 mm˜3 mm. Further, in this embodiment, the runner plate 13 is made by graphite.

It is to be noted that the flow channels 131, in this embodiment, are located on one side of the runner plate 13. In an alternate form of the present invention, as shown in FIG. 4, the flow channels are located on the two opposite sides of the runner plate 13.

The fabrication of the composite bipolar plate is outlined hereinafter. At first, employ a molding process, for example, injection molding, to make the frame 11 having the desired inner edge 111. The material used enables the frame 11 to provide a flexible property. Thereafter, bond the bonding layer 12 to the inner edge 111 of the frame 11, and then bond the milling machine processed runner plate 13 to the bonding layer 12 by, for example, hot-press bonding. Thus, the runner plate 13 and the frame 11 are bonded together by means of the bonding layer 12, forming the desired composite bipolar plate.

A composite bipolar plate made according to the present invention has the advantages as follows:

1. Light weight: The frame 11 is prepared by a polymeric material having a density lower than regular metal materials; in one same dimension, a composite bipolar plate made according to the present invention is lighter than a metal bipolar plate prepared by a metal material.

2. Runner plate crack prevention: The graphite runner plate 13 is bonded to the flexible frame 11 that buffers external pressure, protecting the graphite runner plate 13 against cracking.

3. Low material cost: When compared with a fully graphite bipolar plate, the material cost of the composite bipolar plate of the invention is cheaper. Further, because the frame 11 is suitable for mass production by means of injection molding, the milling machine processing area of the runner plate 11 can be minimized. Therefore, the manufacturing cost of the invention is relatively lower than the conventional bipolar plates.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A composite bipolar plate, comprising:
a frame defining therein an inner edge and a first inlet and a first outlet at said inner edge;
a bonding layer bonded to said inner edge of said frame; and
a runner plate comprising a plurality of flow channels and a second inlet and a second outlet respectively disposed in communication with said flow channels, said runner plate being bonded to said bonding layer and fixedly connected to said frame to have said second inlet be connected to said first inlet and said second outlet be connected to said first outlet for enabling a fuel to flow from said second inlet into said flow channels toward the outside of said runner plate via said second outlet.

2. The composite bipolar plate as claimed in claim 1, wherein said frame has a thickness within the range of 0.75 mm˜3 mm.

3. The composite bipolar plate as claimed in claim 1, wherein said frame is selected from the group of polyester, polyamide, polystyrene, polyolefin consisting of polyethylene and polypropylene, and their copolymers.

4. The composite bipolar plate as claimed in claim 1, wherein said bonding layer is selected from the group of silicone resin, epoxy resin, acrylic resin and bicomponent resins polymerized from polyester and urethane.

5. The composite bipolar plate as claimed in claim 1, wherein said runner plate has a thickness within the range of 0.75 mm˜3 mm.

6. The composite bipolar plate as claimed in claim 1, wherein said flow channels are located on two opposing sides of said runner plate.
